(19) United States
(12) Patent Application Publication
(10) Pub. No.: US 2014/0314265 A1
(43) Pub. Date: Oct. 23, 2014

(54) HEADPHONES WITH ROTATABLE SPEAKER ARRANGED WITHIN HOUSING OF EARPIECE ASSEMBLY

(71) Applicant: LSI CORPORATION, San Jose, CA (US)

(72) Inventor: Joseph M. Freund, Fogelsville, PA (US)

(73) Assignee: LSI Corporation, San Jose, CA (US)

(21) Appl. No.: 13/864,578

(22) Filed: Apr. 17, 2013

(51) Int. Cl. H04R 1/10

(52) U.S. Cl. CPC H04R 1/1066; H04R 1/1041
USPC 381/374

(57) ABSTRACT

A set of headphones comprises first and second earpiece assemblies connected by a headband. At least one of the first and second earpiece assemblies comprises a housing, with a rotatable speaker arranged within the housing and configured to rotate independently of the housing about a designated axis of the earpiece assembly responsive to actuation of a control mechanism. The speaker may be configured to rotate about the designated axis without requiring that the headphones be removed from a head of a user. For example, the rotatable speaker of the earpiece assembly may be configured to rotate between at least first and second positions associated with respective internal and external listening modes in which a front side of the speaker is configured to face in respective inward and outward directions. The rotatable speaker may be further configured to rotate into at least one intermediate position between the first and second positions.

### FIELD

The field relates generally to audio speakers, and more particularly to audio speakers implemented in headphones.

### BACKGROUND

A wide variety of different headphone arrangements are known in the art. In some of these arrangements, the headphones are configured to include multiple sets of speakers, with one set for directing audio output into the ears of a user wearing the headphones and another set for use as external loudspeakers. Other similar arrangements include a single set of speakers but require a user to remove the headphones from his or her head in order to reconfigure the single set of speakers for use as external loudspeakers.

### SUMMARY

In one embodiment, a set of headphones comprises first and second earpiece assemblies connected by a headband. At least a given one of the first and second earpiece assemblies comprises a housing and a rotatable speaker arranged within the housing. The rotatable speaker is configured to rotate independently of the housing about a designated axis of the earpiece assembly responsive to actuation of a control mechanism. The speaker may be configured to rotate about the designated axis without requiring that the headphones be removed from a head of a user.

By way of example only, the rotatable speaker of the earpiece assembly may be configured to rotate between at least first and second positions associated with respective internal and external listening modes in which a front side of the speaker is configured to face in respective inward and outward directions. As another illustrative example, the rotatable speaker may be further configured to rotate into at least one intermediate position between the first and second positions.

Other embodiments of the invention include but are not limited to methods, apparatus and audio playback systems.

### BRIEF DESCRIPTION OF THE DRAWINGS

FIGS. 1, 2 and 3 show a set of headphones in one illustrative embodiment with rotatable speakers arranged in first, second and third rotation positions.

FIGS. 4, 5 and 6 show a set of headphones in another illustrative embodiment with rotatable speakers arranged in first, second and third rotation positions.

FIG. 7 is a block diagram of an audio playback system that includes a set of headphones having rotatable speakers.

FIG. 8 shows an alternative embodiment of the headphones of FIGS. 1-3 with a removable rotatable speaker in each earpiece assembly.

FIG. 9 illustrates the FIG. 8 headphones with one of the removable rotatable speakers removed from its corresponding earpiece assembly.

### DETAILED DESCRIPTION

Embodiments of the invention will be illustrated herein in conjunction with exemplary headphone sets each of which includes at least one earpiece assembly having a rotatable speaker arranged within a housing of the earpiece assembly. It should be understood, however, that embodiments of the invention can be implemented using a wide variety of alternative configurations.

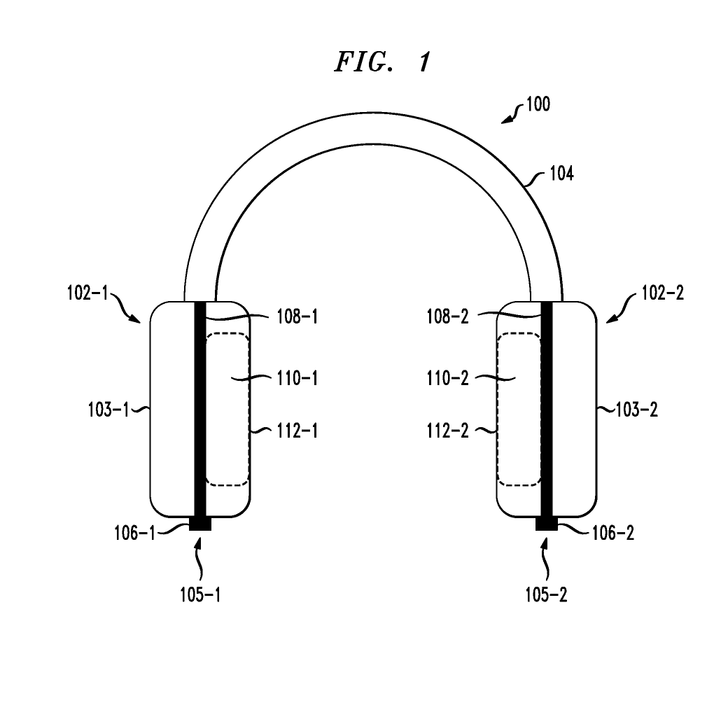

FIG. 1 shows a set of headphones 100 comprising first and second earpiece assemblies 102-1 and 102-2 having respective housings 103-1 and 103-2 each of which contains a rotatable speaker 110 as will be described in more detail below. The earpiece assemblies 102-1 and 102-2 are connected to one another by a headband 104. The headphones 100 are configured in this embodiment to be worn on the head of a user, with the headband 104 passing over the head of the user and the earpieces 102 aligned with respective ears of the user, although other arrangements are possible in other embodiments. Such a user is also referred to herein as a “wearing user.”

The earpiece assemblies 102-1 and 102-2 comprise respective control mechanisms 105-1 and 105-2 for rotating respective rotatable speakers 110-1 and 110-2 arranged within the respective housings 103-1 and 103-2. In the present embodiment, the control mechanisms 105-1 and 105-2 more particularly comprise respective control knobs 106-1 and 106-2 coupled to respective pivoting rods 108-1 and 108-2.

Each of the rotatable speakers 110 is arranged within its corresponding housing 103-1 or 103-2 and configured to rotate independently of that housing about a designated axis of the earpiece assembly 102-1 or 102-2 responsive to actuation of the control mechanism 105-1 or 105-2. The term “independently” as used in this context is intended to be broadly construed, and encompasses arrangements in which the speaker can be rotated by actuation of its associated control mechanism without causing any significant rotation of the associated housing in which the speaker is arranged.

The pivoting rods 108-1 and 108-2 are arranged along the designated axes about which the respective speakers 110-1 and 110-2 rotate under control of the respective control mechanisms 105-1 and 105-2.

The designated axes in the FIG. 1 embodiment are examples of what are more generally referred to herein as longitudinal axes of respective relatively long dimensions of the earpiece assemblies 102-1 and 102-2. When the headphones 100 are deployed on the head of a wearing user and accordingly are arranged as generally shown in FIG. 1, the longitudinal axes, which coincide with and define the rotational axes of the pivoting rods 108-1 and 108-2, are substantially parallel to one another.

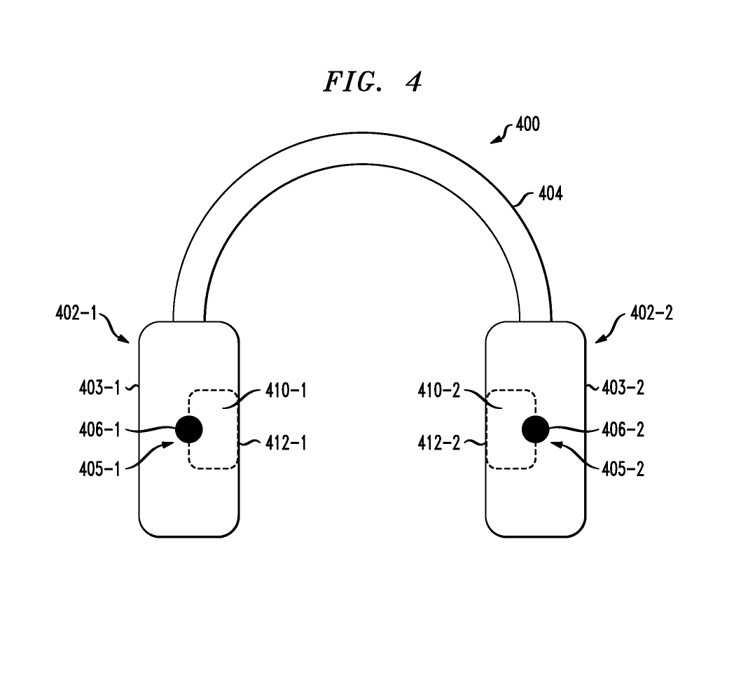

In other embodiments, such as those to be described in conjunction with FIGS. 4, 5 and 6, the designated axes comprise latitudinal axes of respective relatively short dimensions of the earpiece assemblies. Numerous other arrangements and combinations of rotational axes may be used.

As illustrated in FIG. 1, each of the pivoting rods 108 is attached to a back side of the corresponding rotatable speaker 110-1 or 110-2. The front sides of the respective speakers 110-1 and 110-2 are denoted by reference numerals 112-1 and 112-2 in the figure.

Such an arrangement avoids the drawbacks of certain conventional arrangements by permitting a given rotatable speaker to rotate about the designated axis without requiring that the headphones 100 be removed from a head of a wearing user.

A given rotatable speaker 110-1 or 110-2 of headphones 100 is configured to rotate between at least first and second positions associated with respective internal and external listening modes in which the front side 112-1 or 112-2 of the speaker is configured to face in respective inward and outward directions. The first and second positions may correspond to respective approximate 0 degree and approximate 180 degree rotations of the rotatable speaker 110-1 or 110-2 about the corresponding designated axis.

The particular arrangement shown in FIG. 1 illustrates the headphones 100 with both of the rotatable speakers 110-1 and 110-2 rotated into the above-noted first or 0 degree position. As mentioned previously, this position is associated with an internal listening mode in which the front sides 112 of the respective speakers 110 are arranged to direct audio output toward respective ears of the wearing user.

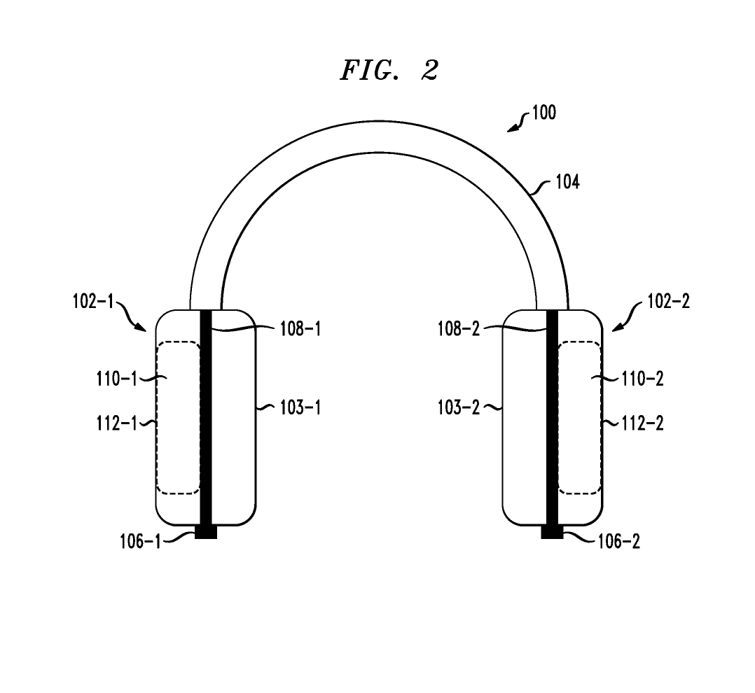

FIG. 2 illustrates the headphones 100 with both of the rotatable speakers 110-1 and 110-2 rotated into the above-noted second or 180 degree position. As mentioned previously, this position is associated with an external listening mode in which the front sides 112 of the respective speakers 110 are arranged to direct audio output away from respective ears of the wearing user and instead into the external environment. The external listening mode allows the current audio selection to be shared with one or more other users in proximity to the wearing user. The wearing user can easily reconfigure each of the speakers 110 between its first and second positions as desired by appropriate actuation of the corresponding one of the control knobs 106.

The headphones 100 in the present embodiment are further configured such that each of the rotatable speakers 110 can be rotated into one or more intermediate positions between the first and second positions described above. For example, a substantially continuous range of positions between 0 and 360 degrees of rotation may be provided, or the speaker as it is rotated may “click” into particular predefined positions, such as the above-noted first and second positions corresponding to approximately 0 degrees and 180 degrees of rotation, respectively, and a third position corresponding to approximately 90 degrees of rotation.

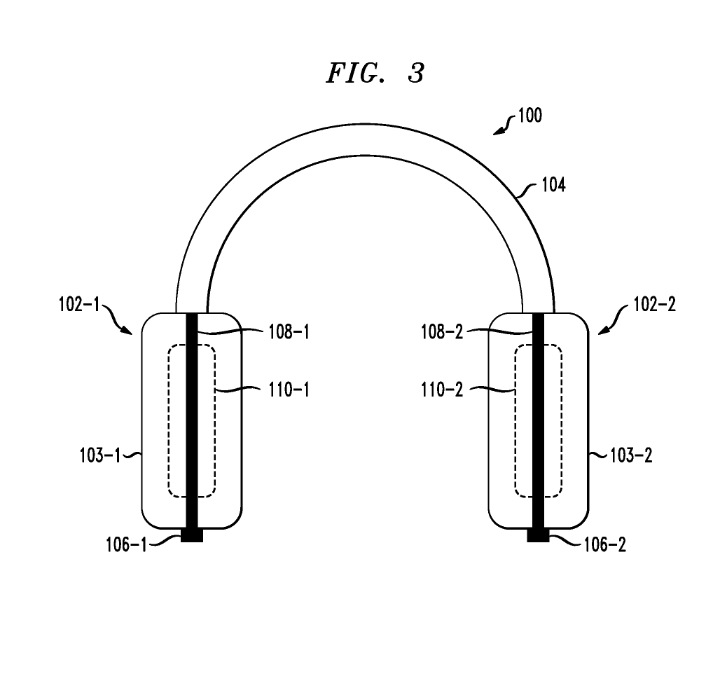

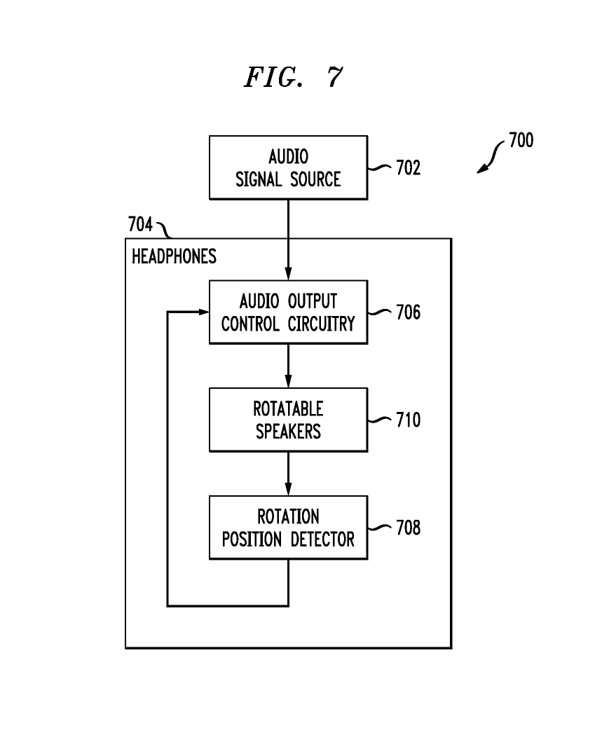

FIG. 3 illustrates the headphones 100 with both of the rotatable speakers 110-1 and 110-2 rotated into the above-noted third or 90 degree position. This position is associated with a third listening mode in which the front sides 112 of the speakers 110 face in a direction that causes audio output of the speakers to be attenuated. For example, the attenuation may be provided by sound absorbing materials within the housing, or through the use of audio output control circuitry that operates responsive to the current rotation position of the speaker, as will be described below in conjunction with FIG. 7.

Accordingly, in this third listening mode, the wearing user can more easily converse with other users in his or her proximity. Again, the wearing user can easily reconfigure each of the speakers 110 between multiple rotation positions as desired by appropriate actuation of the corresponding one of the control knobs 106.

As mentioned above, the rotatable speaker arrangement illustrated in FIGS. 1-3 allows a wearing user to allow other users in his or her vicinity to hear a given audio selection without the wearing user having to remove the headphones.

For example, it is not uncommon for someone to approach the wearing user and to make an inquiry such as “What are you listening to?” The rotatable speaker arrangement of FIGS. 1-3 allows the wearing user to rotate one or both of the speakers 110 to the second position so as to allow the approaching individual to hear the current audio selection. Alternatively or additionally, the wearing user could rotate one or both of the speakers 110 to the third position so as to be able to carry on a conversation with the individual. This avoids the need for the wearing user to remove the headphones in order to converse with the individual or to allow the individual to hear the current selection.

Although the headphones 100 have two earpiece assemblies in the embodiments described above, other embodiments may comprise only a single earpiece assembly. Also, although each of FIGS. 1, 2 and 3 shows both earpiece assemblies 102-1 and 102-2 having their respective rotatable speakers 110-1 and 110-2 rotated into the same first, second or third position, it is possible for the speakers to be rotated into different positions in different earpiece assemblies. Thus, for example, speaker 110-1 may be in the first position while speaker 110-2 is in the second or third position.

It should also be noted that the control mechanism 105 comprising control knob 106 and pivoting rod 108 is just one example of a control mechanism that may be used to rotate a speaker arranged within a housing of an earpiece assembly as disclosed herein. Numerous alternative mechanical or electrical arrangements may be used. For example, the control mechanism in another embodiment may comprise a motorized assembly and a control switch, with the motorized assembly being configured to rotate the rotatable speaker responsive to actuation of the control switch.

Separate control switches may be provided for the respective earpiece assemblies. Alternatively, a single such control switch may be used to control rotation of the speakers in both earpiece assemblies of a set of headphones. In these and other similar control switch arrangements, a given control switch may have multiple switch positions each corresponding to one of the possible positions of the rotatable speakers, such as the 0 degree, 90 degree and 180 degree positions associated with the respective first, second and third listening modes described above.

As mentioned above, different types and arrangements of rotatable speakers may be used in other embodiments. FIG. 4 shows one such embodiment in which a set of headphones 400 comprises first and second earpiece assemblies 402-1 and 402-2 having respective housings 403-1 and 403-2 each of which contains a rotatable speaker 410 as will be described in more detail below. The earpiece assemblies 402-1 and 402-2 are connected to one another by a headband 404.

The earpiece assemblies 402-1 and 402-2 comprise respective control mechanisms 405-1 and 405-2 for rotating respective rotatable speakers 410-1 and 410-2 arranged within the respective housings 403-1 and 403-2. In the present embodiment, the control mechanisms 405-1 and 405-2 more particularly comprise respective control knobs 406-1 and 406-2 that are assumed to be coupled to respective pivoting rods not visible in this view. The control knobs 406 are arranged on front sides of the earpiece assemblies 402 in this embodiment, rather than on bottom sides of the earpiece assemblies as in the previous embodiment.

Each of the rotatable speakers 410 is arranged within its corresponding housing 403-1 or 403-2 and configured to rotate independently of that housing about a designated axis of the earpiece assembly 402-1 or 402-2 responsive to actuation of the control mechanism 405-1 or 405-2. The pivoting rods are arranged along the designated axes about which the respective speakers 410-1 and 410-2 rotate under control of the respective control mechanisms 405-1 and 405-2.

The designated axes are perpendicular to the page in FIG. 4, rather than parallel to the page as in FIG. 1, and are examples of what are more generally referred to herein as latitudinal axes of respective relatively short dimensions of the earpiece assemblies 402-1 and 402-2. When the headphones 400 are deployed on the head of a wearing user and accordingly are arranged as generally shown in FIG. 4, the latitudinal axes, which coincide with and define the rotational axes of the pivoting rods of the respective control mechanisms 405-1 and 405-2, are substantially parallel to one another.

Each of the pivoting rods in the FIG. 4 embodiment is attached to a back side of the corresponding rotatable speaker 410-1 or 410-2. The front sides of the respective speakers 410-1 and 410-2 are denoted by reference numerals 412-1 and 412-2 in the figure.

Like the FIG. 1 embodiment, an arrangement of the type shown in FIG. 4 avoids the drawbacks of certain conventional arrangements by permitting a given rotatable speaker to rotate about the designated axis without requiring that the headphones 400 be removed from a head of a wearing user.

A given rotatable speaker 410-1 or 410-2 of headphones 400 is configured to rotate between at least first and second positions associated with respective internal and external listening modes in which the front side 412-1 or 412-2 of the speaker is configured to face in respective inward and outward directions. The first and second positions may correspond to respective approximate 0 degree and 180 degree rotations of the rotatable speaker 410-1 or 410-2 about the corresponding designated axis.

The particular arrangement shown in FIG. 4 illustrates the headphones 400 with both of the rotatable speakers 410-1 and 410-2 rotated into the above-noted first or 0 degree position. As mentioned previously, this position is associated with an internal listening mode in which the front sides 412 of the respective speakers 410 are arranged to direct audio output toward respective ears of the wearing user.

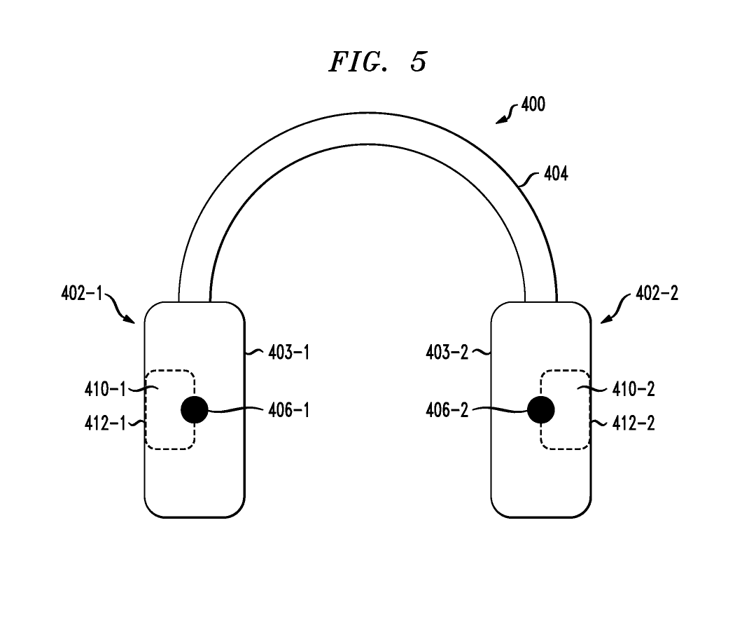

FIG. 5 illustrates the headphones 400 with both of the rotatable speakers 410-1 and 410-2 rotated into the above-noted second or 180 degree position. As mentioned previously, this position is associated with an external listening mode in which the front sides 412 of the respective speakers 410 are arranged to direct audio output away from respective ears of the wearing user and instead into the external environment. The external listening mode allows the current audio selection to be shared with one or more other users in proximity to the wearing user. The wearing user can easily reconfigure each of the speakers 410 between its first and second positions as desired by appropriate actuation of the corresponding one of the control knobs 406.

The headphones 400 in the present embodiment are further configured such that each of the rotatable speakers 410 can be rotated into one or more intermediate positions between the first and second positions described above. For example, a substantially continuous range of positions between 0 and 360 degrees of rotation may be provided, or the speaker as it is rotated may “click” into particular predefined positions, such as the above-noted first and second positions corresponding to approximately 0 degrees and 180 degrees of rotation, respectively, and a third position corresponding to approximately 90 degrees of rotation.

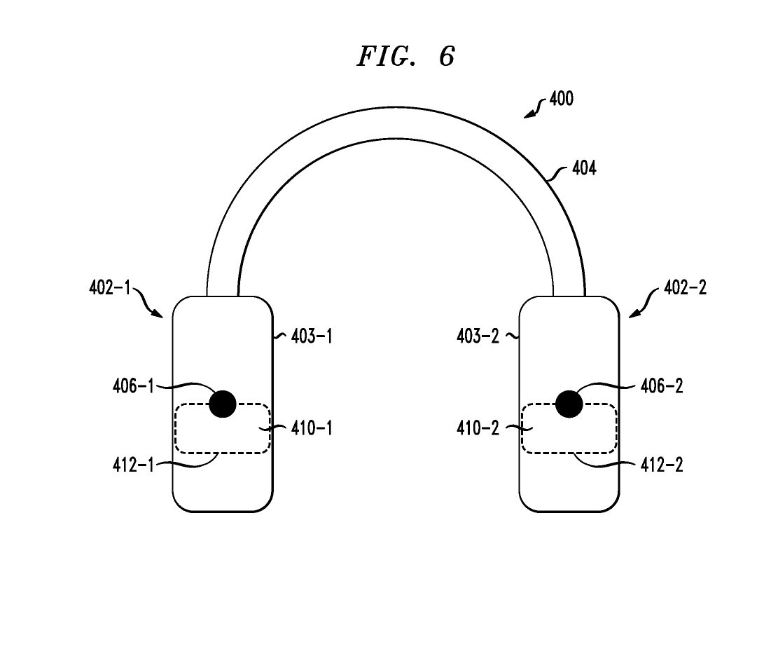

FIG. 6 illustrates the headphones 400 with both of the rotatable speakers 410-1 and 410-2 rotated into the above-noted third or 90 degree position. This position is associated with a third listening mode in which the front sides 412 of the speakers 410 face in a direction that causes audio output of the speakers to be attenuated. Accordingly, in this listening mode, the wearing user can more easily converse with other users in his or her proximity. Again, the wearing user can easily reconfigure each of the speakers 410 between multiple rotation positions as desired by appropriate actuation of the corresponding one of the control knobs 406.

As in the embodiment described in conjunction with FIGS. 1-3, the particular rotational setting of each of the speakers 410-1 and 410-2 can be set independently of that of the other speaker.

Headphones 100 or 400 as described above may be used in an audio playback system. One possible embodiment of such a system is shown in FIG. 7. In this embodiment, an audio playback system 700 comprises an audio signal source 702 such as a digital music player, mobile telephone, computer or radio receiver, and a set of headphones 704 adapted for connection to the audio signal source 702. The audio signal source 702 provides one or more audio signals to audio output control circuitry 706 of the headphones 704. The headphones 704 may be viewed as corresponding to headphones 100 or 400.

The headphones 704 further comprise a rotation position detector 708 and rotatable speakers 710. Each of the rotatable speakers 710 is assumed to be arranged within a housing of a corresponding earpiece assembly of the headphones 704 and configured to rotate independently of the housing about a designated axis of the earpiece assembly responsive to actuation of a control mechanism.

The audio output control circuitry 706 is configured to adjust the audio output of each of the rotatable speakers 710 responsive to a current rotation position of that speaker as determined by the rotation position detector 708. For example, the audio output control circuitry 706 may automatically increase an amount of amplification applied to the one or more audio signals when the speakers are rotated to an external listening mode position, such as that shown in FIG. 2 or 5, relative to an amount of amplification applied when the speakers are rotated to an internal listening mode position, such as that shown in FIG. 1 or 4. Such an arrangement ensures that appropriate adjustments are made to the audio output volume responsive to the current rotation position of the speakers 710.

The audio output control circuitry 706 and other elements of the set of headphones 704 such as the rotation position detector 708 may be implemented at least in part using at least one processing device that comprises a processor coupled to a memory. For example, the processor may be configured to execute software code stored in the memory in order to control the operation of headphone components such as 706 and 708.

The processor may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of circuitry, in any combination.

The memory stores software code for execution by the processor in implementing portions of the functionality of the headphones 704, such as portions of the components 706 and 708. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other circuitry.

It should therefore be understood that embodiments of the invention may be implemented at least in part in the form of integrated circuits. In a given such integrated circuit implementation, identical die are typically formed in a repeated pattern on a surface of a semiconductor wafer. Each die includes circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention. For example, an integrated circuit comprising components such as audio output control circuitry 706 and rotation position detector 708 is considered an embodiment of the invention.

The particular configuration of audio playback system 700 as shown in FIG. 7 is exemplary only, and the system 700 in other embodiments may include other elements in addition to or in place of those specifically shown, including one or more elements of a type commonly found in a conventional implementation of such a system.

Also, the particular headphone configurations illustrated in FIGS. 1 through 6 are exemplary only, and other embodiments may utilize numerous alternative arrangements of headphones or more generally at least one earpiece having a rotatable speaker arranged in a housing thereof. For example, otherwise conventional headphones, including high-end audio headphones and gaming headphones, can be adapted to include rotatable speakers and associated control mechanisms of the type disclosed herein.

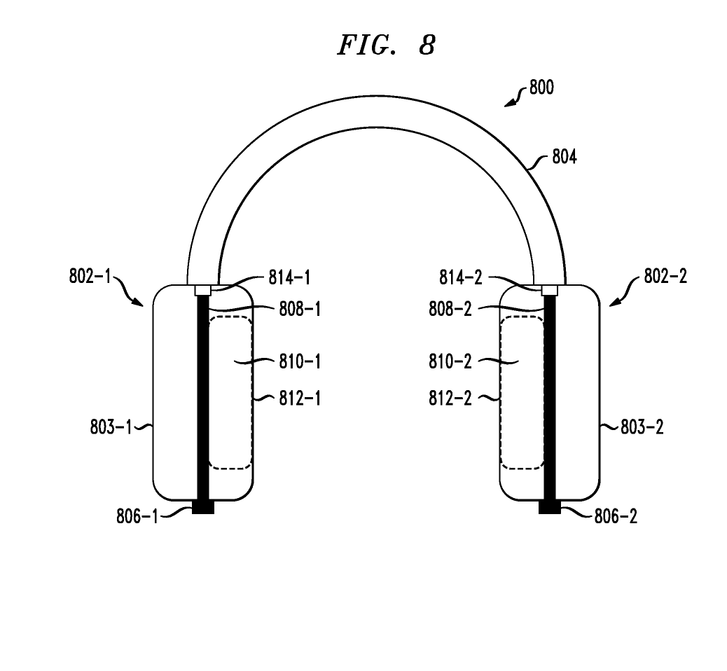

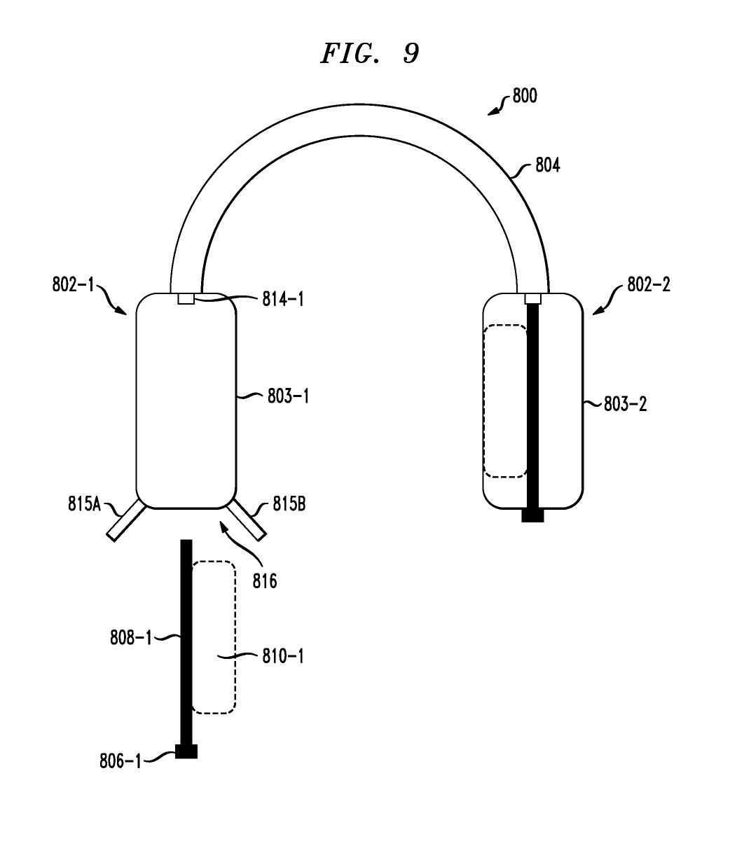

It is also possible that a given set of headphones may be configured such that the rotatable speakers are readily removable therefrom, as will now be described with reference to FIGS. 8 and 9.

FIG. 8 shows an alternative embodiment of the headphones of FIGS. 1-3 with a removable rotatable speaker in each earpiece assembly. This embodiment comprises earpiece assemblies 802-1 and 802-2 connected by a headband 804 and having respective housings 803-1 and 803-2, control knobs 806-1 and 806-2, pivoting rods 808-1 and 808-2, and rotatable speakers 810-1 and 810-2 with front sides 812-1 and 812-2, all arranged in a manner similar to that of the corresponding elements of the FIG. 1 embodiment.

However, in the FIG. 8 embodiment, the pivoting rods 808-1 and 808-2 are detachably coupled to the earpiece assemblies 802-1 and 802-2 via respective connectors 814-1 and 814-2. This permits removal of the pivoting rods 808-1 and 808-2 and the respective rotatable speakers 810-1 and 810-2 attached thereto via openings in lower portions of the respective housings 803-1 and 803-2. In this embodiment, it is assumed that the electrical connections for the rotatable speakers 810-1 and 810-2 pass through the connectors 814-1 and 814-2 and are routed inside the pivoting rods 808-1 and 808-2. Accordingly, all wiring needed to connect the speakers 810 to other portions of the headphones 800 via the connectors 814 is embedded in pivoting rods 808, thereby permitting easy detachment of the speakers and their associated control mechanisms from the respective earpiece assemblies 802.

FIG. 9 illustrates the headphones 800 of FIG. 8 with one of the removable rotatable speakers 810-1 removed from its corresponding earpiece assembly 802-1. More particularly, the rotatable speaker 810-1 and its associated control mechanism comprising control knob 806-1 and pivoting rod 808-1 are detached as a single unit from earpiece assembly 802-1 by decoupling the pivoting rod 808-1 from the connector 814-1. In order to detach and remove this single unit, hinged doors 815A and 815B are first opened outward as shown to create an opening 816 in a lower portion of the housing 803-1. The hinged doors could be implemented to snap back into a closed position when released. Although the removal of the control knob, pivoting rod and rotatable speaker is from an opening in a lower portion of the housing in this embodiment, other embodiments may implement such removal from other openings in the housing. For example, the embodiment of FIGS. 4-6 can be configured for removal of these elements as a single unit from a side opening in the housing.

A removable rotatable speaker arrangement of the type illustrated in FIGS. 8 and 9 allows the speakers to be removed when not in use so as to discourage theft. It also provides an ability to upgrade the speaker quality of the headphones, as a manufacturer could sell a variety of different speakers of different quality levels that all fit the same headphone and earpiece assembly configuration. Repair or replacement of defective speakers is also considerably facilitated.

It should again be emphasized that the embodiments of the invention as described herein are intended to be illustrative only. For example, other embodiments of the invention can be implemented utilizing a wide variety of different types and arrangements of headphones, earpiece assemblies, housings, rotatable speakers, rotation control mechanisms, audio output control circuitry, rotation detectors and other components, than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A set of headphones comprising:
first and second earpiece assemblies connected by a headband;
at least one of the first and second earpiece assemblies comprising:
a housing; and
a rotatable speaker arranged within the housing and configured to rotate independently of the housing about a designated axis of the earpiece assembly responsive to actuation of a control mechanism.

2. The headphones of claim 1 wherein the rotatable speaker is configured to rotate about the designated axis without requiring that the headphones be removed from a head of a user.

3. The headphones of claim 1 wherein the rotatable speaker is configured to rotate between at least first and second positions associated with respective internal and external listening modes in which a front side of the speaker is configured to face in respective inward and outward directions.

4. The headphones of claim 3 wherein the first and second positions correspond to respective approximate 0 degree and approximate 180 degree rotations of the rotatable speaker.

5. The headphones of claim 3 wherein the rotatable speaker is further configured to rotate into at least one intermediate position between the first and second positions.

6. The headphones of claim 5 wherein the intermediate position is associated with a third listening mode in which the front side of the speaker faces in a direction that causes audio output of the speaker to be attenuated.

7. The headphones of claim 5 wherein the intermediate position corresponds to an approximate 90 degree rotation of the rotatable speaker relative to the first position.

8. The headphones of claim 1 wherein the control mechanism comprises a control knob coupled to a pivoting rod that is arranged along the designated axis.

9. The headphones of claim 8 wherein the pivoting rod is attached to a back side of the rotatable speaker and one or more electrical connections for the rotatable speaker are routed at least in part through the pivoting rod.

10. The headphones of claim 9 wherein the pivoting rod is detachably coupled to the earpiece assembly so as to permit removal of the pivoting rod and the rotatable speaker attached thereto via an opening in a portion of the housing.

11. The headphones of claim 1 wherein the control mechanism comprises:
a motorized assembly; and
a control switch;
the motorized assembly being configured to rotate the rotatable speaker responsive to actuation of the control switch.

12. The headphones of claim 1 wherein the designated axis comprises a longitudinal axis of a relatively long dimension of the earpiece assembly.

13. The headphones of claim 1 wherein the designated axis comprises a latitudinal axis of a relatively short dimension of the earpiece assembly.

14. The headphones of claim 1 wherein each of the first and second earpiece assemblies comprises a housing and a rotatable speaker arranged within the housing and configured to rotate independently of the housing about a designated axis of the earpiece assembly responsive to actuation of a control mechanism.

15. The headphones of claim 14 wherein the designated axes of the respective first and second earpiece assemblies comprise respective longitudinal axes of relatively long dimensions of the respective earpiece assemblies such that when the headphones are deployed on a head of a user the longitudinal axes are substantially parallel to one another.

16. The headphones of claim 14 wherein the designated axes of the respective first and second earpiece assemblies comprise respective latitudinal axes of relatively short dimensions of the respective earpiece assemblies such that when the headphones are deployed on a head of a user the latitudinal axes are substantially parallel to one another.

17. The headphones of claim 1 wherein the earpiece assembly further comprises audio output control circuitry configured to adjust an audio output of the rotatable speaker responsive to a current rotation position of the speaker.

18. The headphones of claim 1 wherein the rotatable speaker and its associated control mechanism are detachable as a single unit from the earpiece assembly.

19. A method comprising:
configuring a set of headphones to include first and second earpiece assemblies connected by a headband, with at least one of the first and second earpiece assemblies comprising a housing and a rotatable speaker arranged within the housing; and
providing a control mechanism associated with the rotatable speaker;
wherein the rotatable speaker is configured to rotate independently of the housing about a designated axis of the earpiece assembly responsive to actuation of the control mechanism.

20. The method of claim 19 wherein providing a control mechanism comprises providing a control mechanism that allows the rotatable speaker to rotate between at least first and second positions associated with respective internal and external listening modes in which a front side of the speaker is configured to face in respective inward and outward directions.

21. An audio playback system comprising:
an audio signal source; and
a set of headphones adapted for connection to the audio signal source;
the set of headphones comprising first and second earpiece assemblies connected by a headband;
wherein at least one of the first and second earpiece assemblies comprises:
a housing; and
a rotatable speaker arranged within the housing and configured to rotate independently of the housing about a designated axis of the earpiece assembly responsive to actuation of a control mechanism.

22. An apparatus comprising:
an earpiece assembly comprising a housing and a rotatable speaker arranged within the housing;
wherein the rotatable speaker is configured to rotate independently of the housing about a designated axis of the earpiece assembly responsive to actuation of a control mechanism.
